(19) United States
(12) Patent Application Publication
(10) Pub. No.: US 2009/0059071 A1
(43) Pub. Date: Mar. 5, 2009

(54) SEPARATING DEVICE FOR SEQUENTIAL INTERLACED VIDEO SCREENS

(76) Inventor: Che-Sheng Yu, XiZhi City (TW)

Correspondence Address: ANTHONY R. BARKUME, 20 GATEWAY LANE, MANORVILLE, NY, 11949, US

(21) Appl. No.: 12/198,182

(22) Filed: Aug. 26, 2008

(30) Foreign Application Priority Data
Aug. 29, 2007 (TW) 096132163

(51) Int. Cl. H04N 5/08

(52) U.S. Cl. 348/521; 348/E05.017

(57) ABSTRACT

The present invention relates to a separating device of sequential interlaced video scenes, which comprises the following components: one separating unit of interlaced video scenes; one input unit of interlaced scene video signals, which electrically connects with the separating unit of interlaced video scenes, and provides one interlaced scene video signal to the separating unit of interlaced video scenes; in which, the interlaced scene video signal is integrated by one first scene video signal and one second scene video signal and interlaced combined by time; the separated unit of the interlaced video scenes is able to separate the interlaced scene video signals to the first video scene video signal and the second scene video signal.

### FIELD OF THE INVENTION

The present invention relates to a separating device for sequential interlaced video scenes, particularly to a separating device for separating an interlaced video scene signal into a plurality of video scene signals.

### BACKGROUND OF THE INVENTION

The traditional cameras are able to transfer captured video images to the display devices for showing out through the transmission lines. Newer generation's traditional cameras even comprise built-in web server features, to allow users who would like to see captured video images be able to see them anywhere immediately and very conveniently through the internet connection with the web servers in the network cameras, without any external machines or connection line layout.

But the traditional cameras or network cameras can transfer the video images that are captured by lenses to users for watching only. In the security monitoring system, users need to set up a camera with a transmission line and a power line or a network camera with a network cable or a power line for every scene respectively for watching the video image on each scope. This way is very inconvenient. If a device were able to combine multiple video scene signals together and output to display as an interlaced video scene signal by time, the traditional cameras or network cameras still be not able to separate this interlaced video scene signal to distinct video scene signals.

There are several disadvantages in the technologies of traditional camera devices:

1. In the traditional camera devices into the security monitoring system, every video scene needs to set up a camera respectively, to increase the hardware cost.

2. In the traditional camera devices into the security monitoring system, every camera in every video scene needs to set up transmission line and power line respectively; this is very inconvenient.

3. In the traditional camera devices into the security monitoring system, every camera is not able to separate the captured interlaced video scene signal into distinct video scene signals.

Therefore, how to improve the above traditional disadvantages to allow camera devices being able to separate multiple video scene signals distinctly, is the major topic of the present invention.

### SUMMARY OF THE INVENTION

The objective of the present invention is to provide a new and advanced separating device of sequential interlaced video scenes, which uses an interlaced scene video signal input unit to accept an interlaced scene video signal, to transfer this interlaced scene video signal to an interlaced scene separating unit, and to let this interlaced scene separating unit process the separation of above interlaced scene video signal and recover it to original multiple scene video signals.

According to the present invention, a separating device of sequential interlaced video scenes, which comprises the following components:

One interlaced video scene separating unit;

One interlaced scene video signal input unit, which electrical connects with the interlaced video scene separating unit, and is able to provide an interlaced scene video signal to the interlaced video scene separating unit.

In which, the interlaced scene video signal is combined by one first scene video signal and one second scene video signal in interlacing and by time; the interlaced video scene separating unit is able to separate the interlaced scene video signal to original first scene video signal and the second scene video signal.

In accordance with one aspect of the present invention, the interlaced scene video signal can be combined by more scene video signals in interlacing and by time.

In accordance with one aspect of the present invention, the device is able to separate the interlaced scene video signal to multiple original scene video signals.

In accordance with one aspect of the present invention, the interlaced video scene separating unit also comprises one output switch and multiple output ports.

In accordance with one aspect of the present invention, the output switch unit is able to switch the output signals between the multiple output ports by time, to make the first scene video signal of the interlaced scene video signal can be output from the first output port; the second scene video signal of the interlaced scene video signal can be output from the second output port.

In accordance with one aspect of the present invention, the device is used as the security monitoring application.

In accordance with one aspect of the present invention, the device is able to connect with one sequential interlaced video scene generating device, and to generate interlaced scene video signal by this sequential interlaced video scene generating device to the interlaced scene video signal input unit.

In accordance with one aspect of the present invention, the frame rate of the interlaced scene video signal will be higher than the first scene video signal and the second scene video signal.

The present invention may best be understood through the following description with reference to the accompanying drawing patterns, in which:

### BRIEF DESCRIPTION OF THE DRAWING PATTERNS

FIG. 1 shows the structure diagram of the separating device according to the present invention for sequential interlaced video scenes;

FIG. 2 shows the structure diagram of the separating device combining with generating device according to the present invention for sequential interlaced video scenes.

### DETAILED DESCRIPTION OF THE PREFERRED EMBODIMENT

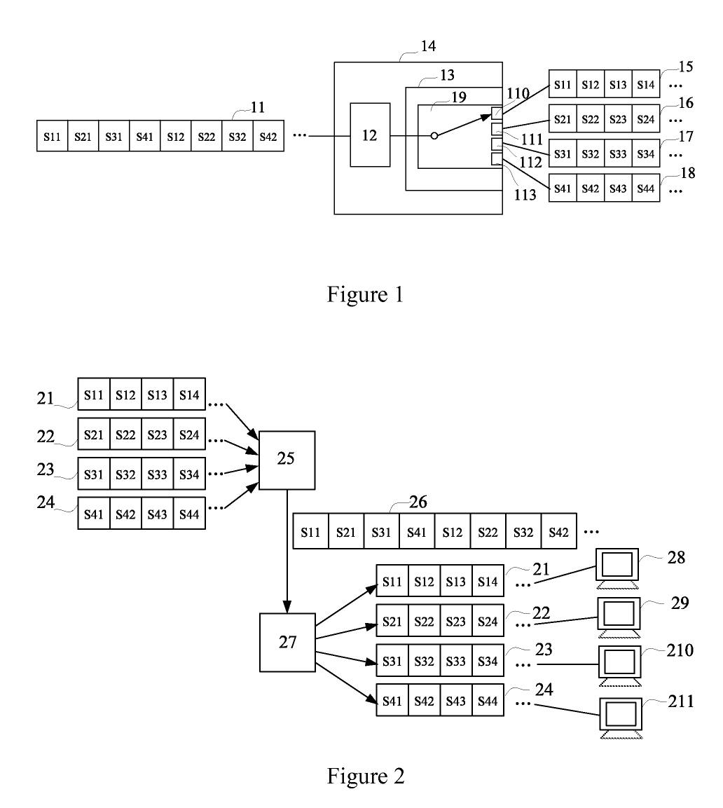

FIG. 1 shows the structure diagram of the separating device according to the present invention for sequential interlaced video scenes, which comprises an interlaced scene video signal 11, an interlaced scene video signal input unit 12, interlaced scene separating unit 13, a sequential interlaced scene separating device 14, a first scene video signal 15, a second scene video signal 16, a third scene video signal 17, a fourth scene video signal 18, an output switch unit 19, a first output port 110, a second output port 111, a third output port 112, and a fourth output port 113.

The separating device 14 of sequential interlaced video scenes of the present invention comprises one interlaced scene video signal input unit 12 and one interlaced scene separating unit 13. This interlaced scene video signals input unit 12 is able to accept one interlaced scene video signal 11 (S11, S21, S31, S41, S12, S22, S32, S42, . . . ), and transfer this interlaced scene video signal 11 to the interlaced scene separating unit 13. Suppose this interlaced scene video signal 11 is combined by the first scene video signal 15, the second scene video signal 16, the third scene video signal 17 and the fourth scene video signal 18. The interlaced scene separating unit 13 will separate the different images (S11, S12, . . . ) in different time in above interlaced scene video signal 11 into sequential first scene video signal 15 (S11, S12, . . . ); separate the different images (S21, S22, . . . ) in different time in above interlaced scene video signal 11 into sequential second scene video signal 16 (S21, S22, . . . ); separate the different images (S31, S32, . . . ) in different time in above interlaced scene video signal 11 into sequential second scene video signal 17 (S31, S32, . . . ); and separate the different images (S41, S42, . . . ) in different time in above interlaced scene video signal 11 into sequential second scene video signal 18 (S41, S42, . . . ); after receiving above interlaced scene video signal 11. The above interlaced video scene separating unit 13 comprises one output switch unit 19, one first output port 110, one second output port 111, one third output port 112, and one fourth output port 113. This output switch unit 19 is able to switch between these multiple output ports by time, to let the first scene video signal 15 can be separated from the interlaced scene video signal and output to the first output port 110, to let the second scene video signal 16 can be separated from the interlaced scene video signal and output to the second output port 111, to let the third scene video signal 17 can be separated from the interlaced scene video signal and output to the third output port 112, and to let the fourth scene video signal 18 can be separated from the interlaced scene video signal and output to the fourth output port 113.

FIG. 2 shows the structure diagram of the separating device according to the present invention for sequential interlaced video scenes, which comprises one first scene video signal 21, one second scene video signal 22, one third scene video signal 23, one fourth scene video signal 24, one sequential interlaced video scene generating device 25, one interlaced scene video signal 26, one sequential interlaced scene separating device 27, one first scene display device 28, one second scene display device 29, one third scene display device 210, and one fourth scene display device 211.

In accordance with the separating device of sequential interlaced video scenes separating device 27 of the present invention, an interlaced scene video signal 26 (S11, S21, S31, S41, S12, S22, S32, S42, . . . ) can be provided by connecting with the sequential interlaced video scene generating device 25. The sequential first scene video signal 21 (S11, S12, S13, S14), the second scene video signal 22 (S21, S22, S23, S24), the third scene video signal 23 (S31, S32, S33, S34), and the fourth scene video signal 24 (S41, S42, S43, S44) are input to the sequential interlaced video scene generating device 25 respectively, and this sequential interlaced video scene generating device 25 will start the interlaced combination for the video signals of these four video scenes by time, to generate one interlaced scene video signal 26 (S11, S21, S31, S41, S12, S22, S32, S42, . . . ), to transfer this interlaced scene video signal 26 to the sequential interlaced video scenes separating device 27, and this sequential video scenes separating device 27 will separate interlaced scene video signal 26 to recover as original sequential first scene video signal 21 (S11, S12, S13, S14), the second scene video signal 22 (S21, S22, S23, S24), the third scene video signal 23 (S31, S32, S33, S34), and the fourth scene video signal 24 (S41, S42, S43, S44) by time after receiving this interlaced scene video signal 26, and to transfer to the first scene display device 28, the second scene display device 29, the third scene display device 210, and the fourth scene display device 211 for showing out, respectively. Of course, we may use direct transferring by electrical signal between the sequential interlaced video scene generating device 25 and sequential interlaced video scenes separating device 27, or by optical signal solution, and there is a synchronization mechanism between above two devices for making sure they are able to work well.

In practical implementations, the video frame rate of the first scene video signal 21 (S11, S12, S13, S14), the second scene video signal 22 (S21, S22, S23, S24), the third scene video signal 23 (S31, S32, S33, S34), and the fourth scene video signal 24 (S41, S42, S43, S44) can be 30 F/S (Frame per second), but the video frame rate of interlaced scene video signal 26 (S11, S21, S31, S41, S12, S22, S32, S42, . . . ) can be 120 F/S (Frame per second).

There are several advantages of the present invention:

1. In accordance with the separating device of sequential interlaced video scenes of the present invention, multiple video images of different video scenes can be shown out by connecting with this sequential interlaced scene generating device without setting up several camera devices.

2. In accordance with the separating device of sequential interlaced video scenes of the present invention, we may save the hardware cost of redundant camera devices and setting up cost.

3. In accordance with the separating device of sequential interlaced video scenes of the present invention, the set up of infrastructure will be much easier and faster without setting up many camera devices.

To sum up, the separating device of sequential interlaced video scenes of the present invention uses one interlaced scene video signal input unit to receive one interlaced scene video signal, transfers this interlaced scene video signal to one interlaced video scene separating unit, and starts the separating process for the received interlaced scene video signal by this interlaced video scene separating unit, in order to separate this interlaced scene video signal as multiple original scene video signals, which is an advanced, new, and practical. All the design changes that based on theory of the present invention, just likes the different types of interlaced video scene separating units, different interlaced scene video signal input units, or different devices to provide interlaced scene video signals, are covered by the present invention if any architecture was able to separate an interlaced scene video signal into multiple original scene video signals.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A separating device for sequential interlaced video scenes comprising:
an interlaced video scene separating unit;
an interlaced scene video signal input unit, which electrically connects with the interlaced video scene separating unit, and is able to provide an interlaced scene video signal to the interlaced video scene separating unit;
in which, the interlaced scene video signal is combined by a first scene video signal and a second scene video signal in interlacing and by time;
the interlaced video scene separating unit is able to separate the interlaced scene video signal to recover the first scene video signal and the second scene video signal.

2. A device according to claim 1, wherein the interlaced scene video signal can be combined by more scene video signals in interlacing and by time.

3. A device according to claim 2, wherein the interlaced scene video signal is separated to recover multiple scene video signals.

4. A device according to claim 1, wherein the interlaced video scene separating unit also comprises an output switch and multiple output ports.

5. A device according to claim 4, wherein the output switch unit is able to switch the output signals between the multiple output ports by time, to make the first scene video signal of the interlaced scene video signal can be output from the first output port; the second scene video signal of the interlaced scene video signal can be output from the second output port.

6. A device according to claim 1, wherein the security monitoring is applied.

7. A device according to claim 1, wherein a sequential interlaced video scene generating device is connected for generating the interlaced scene video signal to the interlaced scene video signal input unit.

8. A device according to claim 1, wherein the frame rate of the interlaced scene video signal is higher than the first scene video signal and the second scene video signal.
